(19) United States
(12) Patent Application Publication
(10) Pub. No.: US 2011/0301748 A1
(43) Pub. Date: Dec. 8, 2011

(54) UNIT FOR CHARGING A BATTERY OF A PORTABLE ELECTRIC DEVICE

(76) Inventor: Romain Lecarpentier, Villefontaine (FR)

(21) Appl. No.: 13/133,665

(22) PCT Filed: Dec. 8, 2009
(86) PCT No.: PCT/FR09/52444

§ 371 Date: Aug. 25, 2011

(30) Foreign Application Priority Data
Dec. 9, 2008 (FR) 0858396

(51) Int. Cl. G07D 11/00; H02J 7/00

(52) U.S. Cl. 700/232; 320/137

(57) ABSTRACT

The invention relates to a unit for charging a battery of a portable electric device, said unit including: an electric power supply unit; at least one charging area that is provided with at least two different types of coupling interfaces, each of which is suitable for enabling a connection or a coupling between a portable electric device and the supply unit; a selection means for enabling the selection, by a user, of at least one of the coupling interfaces; and a control unit for controlling the electric power supply unit according to the selection made by the user.

The present invention relates to a unit, suitable for charging the battery of portable electric devices, such as portable telephones, MP3 players or any other electric device that uses a battery.

Such devices comprise a battery whose charge level directly determines the autonomy of the device. If the use of the device is prolonged, it then becomes necessary to charge the battery. Conventionally, a battery charger is used which comprises a connection element which adapts directly to one of the outputs of the electric device. The user must also be close to a power plug so as to be able to directly connect the charger to this plug.

However, each brand of electric device generally allows for the use of only a single type of battery charger. This compatibility is sometimes even limited to a single model of electric device of the same brand. The recharging of a battery of the device with electric current is then restricted for the user.

GB-A-2 440 007 includes various wired connection elements for recharging different electric devices. However, there are electric devices whose wired connectors are incompatible with the unit of GB-A-2 440 007. Furthermore, a wired charging may prove relatively lengthy to complete.

The aim of the present invention is to provide a unit for charging a battery of an electric device that enables the user to charge his electric device easily, and preferably rapidly, notably in public places.

To this end, the subject of the invention is a unit for charging a battery of a portable electric device, comprising:
an electrical energy supply unit,
at least one charging zone, equipped with at least two coupling interfaces which are each designed to allow for a connection or a coupling between a portable electric device and the supply unit,
a selection means, suitable for allowing for the selection by a user of at least one of the coupling interfaces, and
a control unit which is suitable for controlling the electrical energy supply unit according to the selection of the user.

One of the coupling interfaces comprises a first module positioned in at least one charging zone and suitable for transmitting to a second module, positioned in at least one portable electric device, the electrical energy by electromagnetic coupling.

By virtue of the charging unit according to the invention, the user can charge his electric device easily, practically and safely.

According to other advantageous but optional characteristics of the unit for charging a battery of an electric device according to the invention, taken in isolation or in all technically possible combinations:
at least one charging zone is formed in a cell associated with a door;
the control unit is suitable for driving locking and/or unlocking means for the door or at least one of the doors;
the door or at least one of the doors is partly transparent;
at least one charging zone comprises at least two coupling interfaces each comprising an element for connecting to a portable telephone;
at least one of the coupling interfaces comprises a connection element of USE socket type;
at least one of the coupling interfaces comprises a connection element, suitable for connecting to a multimedia device of IPHONE or IPOD type;
the selection means comprises a control screen;
the unit also comprises payment means, the control unit being suitable for allowing for the supply of a quantity of energy corresponding to the amount paid by the user or for having the user pay the sum of money corresponding to the quantity of electrical energy supplied to charge the battery of his electric device.

The invention will be better understood from reading the following description, given solely as a nonlimiting example, and with reference to the drawings in which:

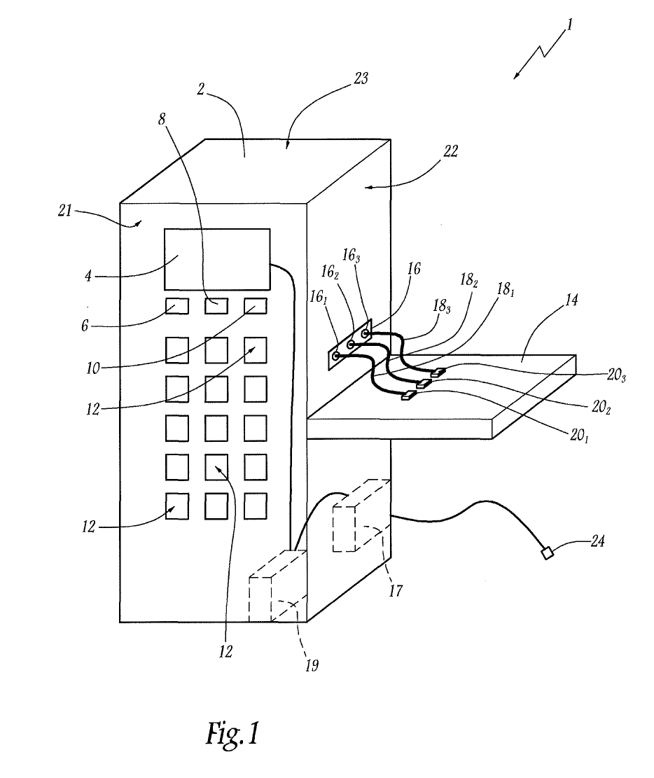

FIG. 1 represents a schematic view in perspective of a unit for charging a battery of a portable electric device according to the present invention;

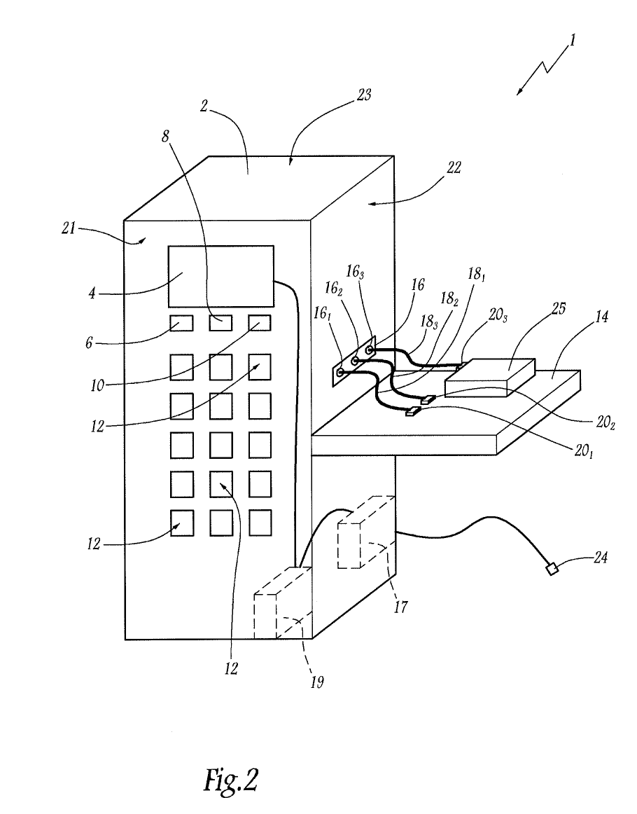

FIG. 2 represents a schematic view in perspective of the unit for charging a battery of an electric device during use;

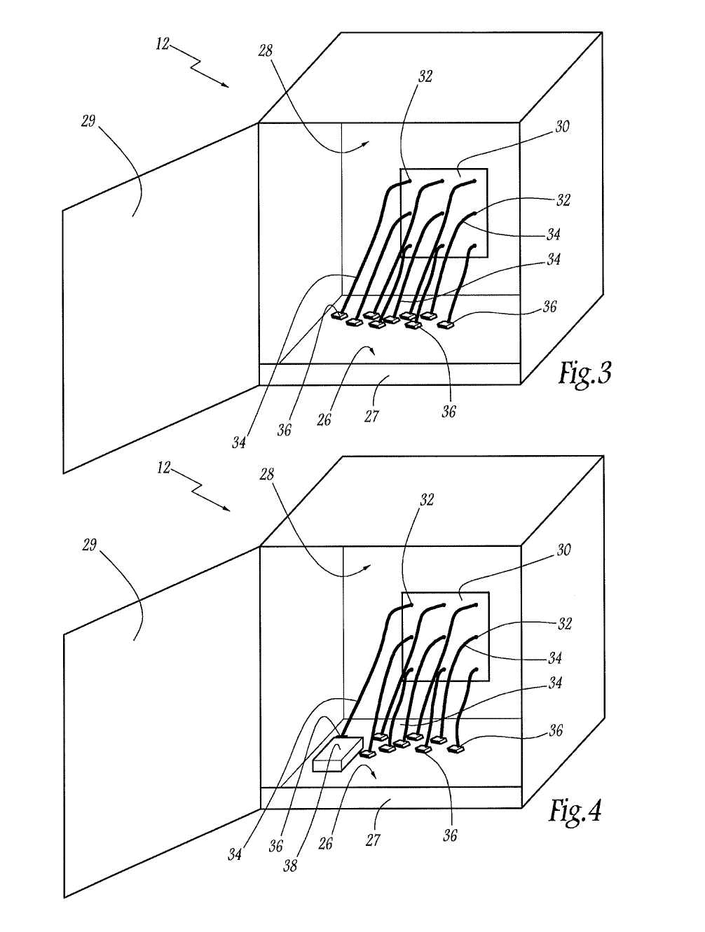

FIG. 3 represents a schematic view in perspective of an isolated cell of the unit, the door of the cell being open; and

FIG. 4 represents a schematic view in perspective of the cell during use.

FIGS. 1 and 2 represent a unit 1 that makes it possible to charge a battery of an electric device. The unit 1 comprises an enclosure 2 substantially of parallelepipedal shape. FIGS. 1 and 2 show a front face 21, a side wall 22 adjacent to the front face and a top face 23.

On the front face 21, there is a selection means 4 placed above a receipt ticket printer 10, a numeric keypad 8 and a magnetic and/or chip payment card reader 6. The numeric keypad 8 is positioned between the reader 6 and the printer 10. The selection means 4 is a touch control screen. As an alternative, the selection means may comprise buttons, thumbwheels or even control drums.

On the central part of the front face 21 there are cells 12, twelve of them, substantially evenly distributed over four rows and three columns.

The enclosure 2 also includes a power plug 24 intended to provide the electrical power supply for the unit 1. The plug is designed to operate with a voltage that may be, for example, 220 volts. The plug 24 is connected to an electrical energy supply unit 17. The unit 17 is driven by a control unit 19 in relation to the instructions given by the user by means of the screen 4.

Furthermore, the enclosure 2 may be mounted on movement means (not represented), so as to facilitate its strategic positioning in public places. As a nonlimiting example, the movement means may be four casters respectively positioned at the four corners of the bottom face of the enclosure 2.

A shelf 14 is positioned securely attached and perpendicular to the side face 22. As an example, the shelf 14 may be fixed by means of screws or by gluing. Advantageously, the shelf 14 is placed at a height enabling a user of average size to place his elbows on the shelf, when in a so-called standing position in front of the unit 1. On the part of the side wall 22 situated above the shelf 14 there is a panel 16 comprising three openings 16₁, 16₂ and 16₃. The three openings respectively allow for the passage of three connecting wires 18₁, 18₂ and 18₃ qualified as external, to the ends of which are fixed three connection elements 20₁, 20₂ and 20₃, also said to be external.

It will be noted that the length of the connecting wires makes it possible for the connection elements to rest on the shelf 14. The absence of the shelf 14 may also be provided for. In this case in point, the connection elements hang loose. Provision may also be made to fix a shelf to the rear face and/or to the second side wall positioned opposite to the wall 22 relative to the front face 21.

FIG. 2 shows the unit 1 during use. The connection element 20₃ is fixed to an electric device 25, the device resting on the shelf 14. Thus, a so-called external or open charging zone is defined, equipped with three coupling interfaces comprising the three connecting wires and the three connection elements.

FIG. 3 shows an enlargement of one of the cells 12 of the unit 1. The cell 12 comprises a door 29 which is in the open position in FIG. 3, whereas it is in the closed position in FIGS. 1 and 2 for each of the twelve cells. The cell also comprises a floor 26 and a back plate 28, positioned, both perpendicularly to the floor 26 and parallel to the door 29 when the door is in the so-called closed position. The floor 26 also has a raised edge 27 adjacent to the door 24, when the door is closed. The floor 26 may consist of a tray covered with silicone. The tray may be removable or securely attached to the cell 12. Alternatively, a means for receiving an electric device may be a support fixed to an internal face of the door 29. The support may have the flexible structure of a pocket. A rigid frame may also be envisaged. As a nonlimiting example, each of the cells may have a height of approximately 20 cm, a depth of approximately 15 cm and a width of approximately 15 cm.

Advantageously, the door 29 is partly transparent.

The back plate 28 has a panel 30 fixed to it comprising nine holes 32, evenly distributed over the panel. These holes 32 are formed substantially adjacent to nine other holes produced in the back plate 28. It should be noted that the presence of a panel 30 may be dispensed with. Each of the holes allows for the passage of a so-called internal connecting wire 34. Each of these connecting wires has at one of its ends an internal connection element 36. The second end of each of the wires 34 is, as an example, securely attached to an electric terminal (not represented), ensuring the supply of electric current to the wires 34 and the connection elements 36. In fact, the electric terminal is connected to the electrical energy supply unit 17. The enclosure 2 may comprise a plurality of terminal blocks, these terminal blocks being themselves possibly provided with a number of electric terminals. The length of the connecting wires 34 is such that the connection elements 36 rest on the floor 26.

Thus, in each of the cells, there is formed a so-called internal or secured charging zone, equipped with nine coupling interfaces, each defined by the connecting wire 34 and the connection element 36.

Each of the connection elements 36 is designed to be able to be fixed to a given electric device. It should be noted that the number of connection elements 36 is not necessarily limited to nine. In practice, it is possible to provide a number of connection elements designed to make it possible to cover, for example, 80% of the market in portable telephones and 80% of the market in digital players of MP3 type. The operator of the unit 1 may continually adapt to the trend of the market in electronic devices by simply replacing the obsolete connection element with a new connection element.

Similarly, the number of external connection elements 20₁, 20₂, 20₃ is not necessarily limited to 3.

Advantageously, the connecting wires 18₁, 18₂, 18₃ and 34 are each connected by a jack plug to a terminal block comprising corresponding jack sockets. Thus, the wires positioned in the cell 12 or on the external side face 22 are easily exchangeable or interchangeable.

Advantageously, the connection element 36 of at least two coupling interfaces may be simply a pin. Thus, the two pins may be fixed directly to the battery. This system is notably suitable for the charging of batteries used by old portable telephone models.

Each of the cells 12 may contain a locking means (not shown in the figures). The locking means may be, as a nonlimiting example, a tab positioned on an edge of the door 29. This mobile tab may be adjacent to an opening formed in the enclosure 2 adjacent to the frame of the cell. When the tab is received through the opening, the cell 12 is in a so-called locked configuration. The movement of the tab may be driven by the control unit 19. By way of alternatives, magnetic locking means may be provided, whose management is also handled by the control unit 19. Thus, since the cells are closed without a key, any risk of loss of such a key by the user of the unit 1 is avoided.

Moreover, as an alternative to the so-called leaf door 29, provision may be made to use a so-called sliding door for each of the cells 12. The flap forming the door is then designed to slide along the frame of the cell 12.

FIG. 4 represents the cell 12 before the imminent use of the unit 1. An electronic device 38 is securely attached to a connection element 36. It will be noted that the presence of the raised edge 27 makes it possible to avoid dropping the device 38.

The coupling interfaces may notably comprise connection elements suitable for fixing to portable telephones.

Moreover, this type of interface may also comprise a connection element of USB socket type or designed to be connected to a multimedia device of IPHONE or IPOD type.

When a user considers that his electric device has insufficient autonomy, he stands in front of the unit 1 and chooses on the selection means 4 the function aiming to enable him to charge the battery of his device. He then inserts his payment card into the reader 6 and taps in his four-digit confidential code. At this moment, the imprint of the card is taken. These various operations are managed by the control unit 19 by virtue of the selection means 4.

The user then chooses either one of the available cells 12 or the open charging zone positioned on the shelf 14. If he chooses one of the cells 12, the door 29 is unlocked by the control unit 19 and the user may proceed to manually open it. The user may then connect his electric device to the connection element 36 directly suited to his device.

Once this operation is completed, the cell is closed and the charging of the device with electric current can begin. The distribution of electrical energy by the supply unit 17 is then enabled by the control unit 19.

So as to improve security, the user may be prompted to enter a four-digit code in addition to that of the bank card. Thus, an ill-intentioned third party, having obtained the payment card of the user, may not be able to recover the electric device during charging in the unit 1.

If the user selects the external charging zone positioned on the side face 22, the distribution of the electrical energy is managed in the same way as previously. The charging of the battery may thus be performed while the user is using his telephone.

The control unit 19, by actuation of the selection means 4, controls the arrival of electrical energy and manages its distribution so as to charge the battery of the electric device.

When the user wants to retrieve his electric device, he begins by selecting the appropriate function on the selection means 4. The user inserts his payment card and enters the four-digit confidential code. He is now identified. The control unit 19 stops the distribution of electrical current by the supply unit 17. Then, the leaf door 29 of the cell 12 used is unlocked and the user can open the door. He can then retrieve his device by disconnecting it from its connection element. The sequence of operations is substantially the same if the user has selected the external charging zone.

It should be noted that the steps of the method for using the unit 1 and their sequencing have been given in a purely indicative and non-restrictive manner.

Provision may be made for the user to select a predetermined sum of money which is then debited from his account and which is converted into a quantity of electrical energy delivered during the charging step, including the fixed cost of the service, by the control unit 19. This thus enables the user to control his budget.

It will be noted that the selection means 4 is common to all the charging zones, namely the secured charging zones arranged in the cells 12 and the open charging zone positioned along the side wall 22.

Furthermore, the unit 1 comprises at least one non-wired coupling interface. In other words, the wireless coupling interface comprises a first module positioned in one of the charging zones. The electronic device is equipped with a second module. The control unit 19 may then enable the charging of the battery of the electric device by electromagnetic coupling between the two modules. Provision may thus be made to implement by any appropriate means a power transfer system not requiring direct electrical contact between the battery of the portable device and the charging zone. This technology may also make it possible to provide a total charge for the battery in approximately fifteen minutes. This should be seen in perspective relative to a standard wired charging lasting approximately two hours.

Advantageously, provision may be made for several electric devices to be charged simultaneously in the same cell 12.

Moreover, provision may be made for payment means other than the use of a bank card. To this end, the enclosure 2 may include a device making it possible to insert coins or banknotes.

As an indication, the unit 1 may have a height of between 1.50 meters and 2 meters, a width of between 50 cm and 1 meter and a depth of between 50 cm and 1 meter.

Furthermore, the enclosure 2 comprises the conventional electrical elements necessary for the operation of the unit 1, namely, notably, a power switch box, a power transformer, safety breakers, electrical power supplies for the reader 6, for the keypad 8, for the printer 10 and for the selection means 4.

In the claims:

1. A unit for charging a battery of a portable electric device, comprising:
an electrical energy supply unit,
at least one charging zone, equipped with at least two coupling interfaces which are each designed to allow for a connection or a coupling between a portable electric device and the supply unit,
a selection means, suitable for allowing for the selection by a user of at least one of the coupling interfaces, and
a control unit which is suitable for controlling the electrical energy supply unit according to the selection of the user,
characterized in that at least one of the coupling interfaces comprises a first module positioned in at least one charging zone and suitable for transmitting to a second module, positioned in at least one portable electric device, the electrical energy by electromagnetic coupling.

2. The unit as claimed in claim 1, characterized in that at least one charging zone is formed in a cell associated with a door.

3. The unit as claimed in claim 2, characterized in that the control unit is suitable for driving locking and/or unlocking means for the door or at least one of the doors.

4. The unit as claimed in claim 2, characterized in that the door or at least one of the doors is partly transparent.

5. The unit as claimed in claim 1, characterized in that at least one charging zone comprises at least two coupling interfaces each comprising an element for connecting to a portable telephone.

6. The unit as claimed in claim 1, characterized in that at least one of the coupling interfaces comprises a connection element of USB socket type.

7. The unit as claimed in claim 1, characterized in that at least one of the coupling interfaces comprises a connection element, suitable for connecting to a multimedia device of IPHONE or IPOD type.

8. The unit as claimed in claim 1, characterized in that the selection means comprises a control screen.

9. The unit as claimed in any one of the preceding claims claim 1, characterized in that it also comprises payment means, the control unit being suitable for allowing for the supply of a quantity of energy corresponding to the amount paid by the user or for having the user pay the sum of money corresponding to the quantity of electrical energy supplied to charge the battery of his electric device.
